(19) United States
(12) Patent Application Publication
(10) Pub. No.: US 2019/0001764 A1
(43) Pub. Date: Jan. 3, 2019

(54) TIRE PRESSURE MONITORING UNIT

(71) Applicant: Huf Hülsbeck & Fürst Gmbh & Co. KG, Velbert (DE)

(72) Inventors: Markus Wagner, Ludwigsburg (DE); Van Hieu Nguyen, Hildesheim (DE)

(21) Appl. No.: 16/017,167

(22) Filed: Jun. 25, 2018

(30) Foreign Application Priority Data
Jun. 30, 2017 (DE) 10 2017 114 721.7

(51) Int. Cl. B60C 23/04; G07C 5/00; G07C 5/08

(52) U.S. Cl. CPC B60C 23/0422; G07C 5/085; G07C 5/008

(57) ABSTRACT

A tire pressure monitoring unit has a pressure sensor for measuring the tire pressure and a printed circuit board which carries an antenna circuit for transmitting pressure data. The antenna circuit is designed to transmit pressure data by means of Bluetooth low-energy technology and for this purpose has an antenna, the ends of which are secured on the printed circuit board.

### CROSS-REFERENCE TO RELATED APPLICATIONS

This application claims priority to German Patent Application No. 10 2017 114 721.7, filed Jun. 30, 2017, the entire contents of which are hereby incorporated by reference.

### DESCRIPTION

### Field of the Invention

The invention is based on a tire pressure monitoring unit with the features specified in the preamble of claim 1, as known, for example, from DE 199 39 936 A1.

### Background of the Invention

Tire pressure monitoring units include a pressure sensor for measuring tire pressure and an antenna circuit for transmitting pressure data. Currently used tire pressure monitoring units transmit pressure data in the 433 MHz range. In addition, tire pressure monitoring units are also known to transmit pressure data in the 315 MHz or 868 MHz range instead.

The antenna circuit including the associated antenna causes a considerable part of the manufacturing costs of a tire pressure monitoring unit. In addition, the transmission activity of a tire pressure monitoring unit accounts for the largest part of its energy demand.

It is therefore an object of the invention to show how tire pressure monitoring can be further improved with regard to its transmitting device.

### SUMMARY OF THE INVENTION

This object is achieved by a tire pressure monitoring system with the features specified in the independent claim. Advantageous refinements of the invention are subject matter of dependent claims.

A tire pressure monitoring system according to the present invention is configured to transmit pressure data using Bluetooth low-energy technology (hereinafter Bluetooth LE).

Bluetooth LE is an industry standard for wireless data transmission in the 2.4 GHz range. The ISM frequency band at 2.4 GHz is divided into 40 channels with a width of 2 MHz each. Data is transmitted as packets or telegrams that are sent on one of these channels, wherein the channel must be changed after each packet or telegram. Each packet starts with a Bluetooth-LE identification of 8-bit, followed by a 32-bit access identification, before up to 39 bytes of user data and a 24-bit checksum.

The size of a data packet in Bluetooth LE therefore corresponds to the size of a typical data packet typically transmitted by a conventional tire pressure monitoring system to transmit temperature and pressure data. Bluetooth LE is therefore very well suited for the transmission activity of tire pressure monitoring systems. In addition, it features an advantageously low transmission energy and a cost-effective production of corresponding antenna circuits, since these or their essential elements are required in very large numbers for the most diverse applications.

A special feature of the transmitting device of a tire pressure monitoring unit according to the invention is that it has an antenna circuit with a bracket antenna, the ends of which are secured on the printed circuit board. In a tire pressure monitoring unit, a space of only a few centimeters in length is available for an antenna. Therefore, for a frequency range of 2.4 GHz, magnetic antennas, in particular bracket antennas, are particularly well suited for transmitting radio signals for geometric reasons.

A further advantageous refinement of the invention provides that the bracket antenna extends along a diagonal of the printed circuit board. In this manner, the available installation space in the housing of a tire pressure monitoring system can be used particularly efficiently to enable an antenna with a sufficiently large length for transmissions in the 2.4 GHz frequency range.

The ends of the antenna can simply be soldered onto the printed circuit board. However, the ends of the bracket antenna are preferably plugged into the circuit board, since a mechanically more reliable connection can be implemented in this manner, which is an important advantage due to the high forces occurring in a tire. This plug connection can be additionally secured by a soldered connection. In order to further improve the quality of the plug connection, each end of the bracket antenna can have a plurality of pins that are plugged into corresponding holes in the printed circuit board.

Another advantageous refinement of the invention is that the bracket antenna is a sheet metal strip. For example, the bracket antenna can be made of a piece of wire; however, a sheet metal strip has greater mechanical stability. This applies in particular if the sheet metal strip has a bead, in particular a longitudinal bead. The sheet metal strip forming the antenna can have a main section extending parallel to the printed circuit board. A longitudinal bead for mechanical stabilization is particularly advantageous in a curvature adjoining the main section. The main section may have a widened region, especially in its center. One end of the longitudinal beads then preferably lies in the main section between the widened region and the nearest curvature, the other end of the longitudinal beads, as seen from the main section, lies behind the curvature.

Another advantageous refinement of the invention is that the printed circuit board additionally carries a second antenna circuit which is designed to transmit pressure data in a frequency range of 433 MHz by means of the bracket antenna, and that the tire pressure monitoring unit includes a control circuit which selects which of the two antenna circuits is to be used to transmit pressure data. In this way, the tire pressure monitoring system can selectively be used with conventional tire pressure monitoring systems in which pressure data is transmitted in the frequency range of 433 MHz. Thus, the tire pressure monitoring system can also be used, for example, to replace a tire pressure monitoring unit of a conventional tire pressure monitoring system consisting of one tire pressure monitoring unit per vehicle tire and a central unit.

### BRIEF DESCRIPTION OF THE DRAWINGS

Further details and advantages of the invention are illustrated by means of an illustrative embodiment with reference to the attached drawings. Same and corresponding components are designated therein with same reference signs.

In the Figures:

FIG. 1 shows a schematic illustration of a tire monitoring system having a transparent housing; and

FIG. 2 shows a schematic illustration of the printed circuit board of the tire pressure monitoring system shown with antenna circuit and bracket antenna.

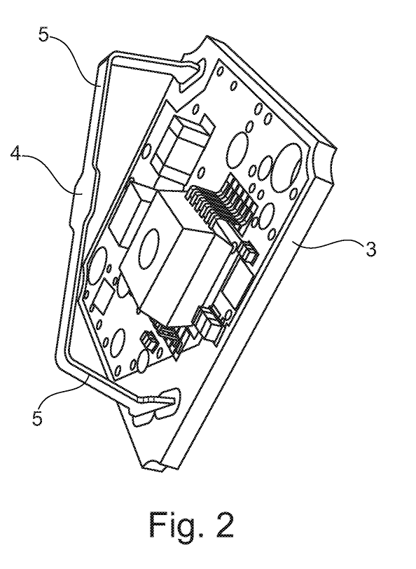

### DETAILED DESCRIPTION OF THE PREFERRED EMBODIMENTS

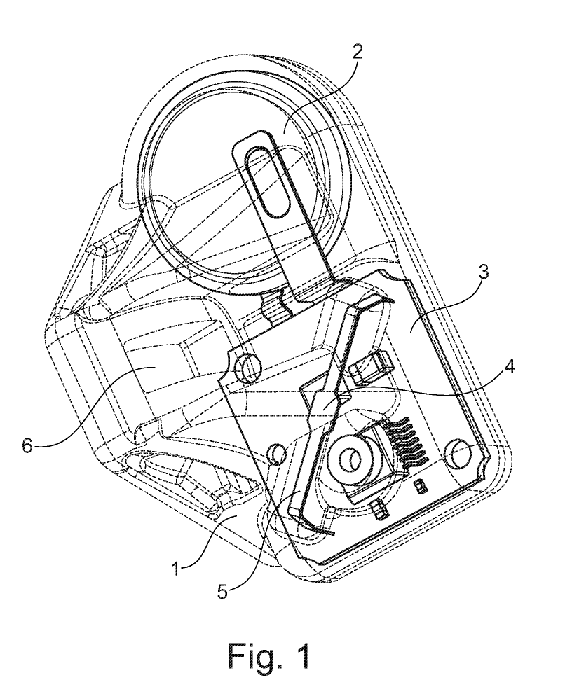

The tire pressure monitoring unit shown schematically in FIG. 1 has a housing 1 made of plastics in which a power source 2, for example a battery or a generator, and a printed circuit board 3 are arranged. The printed circuit board 3 carries pressure and temperature sensors, a control unit, for example a microcontroller, and a transmitter, which has an antenna circuit with a bracket antenna 4, for transmitting pressure and temperature data.

The transmitter with the antenna circuit and the bracket antenna 4 are designed to transmit pressure and temperature data via Bluetooth LE technology, thus to wirelessly transmit pressure and temperature data in data packets according to the Bluetooth LE standard. The two ends of the bracket antenna 4 are plugged into the printed circuit board 3. For this purpose, the bracket antenna 4 has a plurality of plug contacts at each of its ends, which are plugged into corresponding holes of the printed circuit board 3. The plug contacts can be formed as press-in contacts or can be additionally secured by soldering.

In the embodiment shown, the bracket antenna 4 has a main section that runs parallel to the printed circuit board 3, but can also have a different shape. End sections are connected to the main section on both sides, which run obliquely or curved to the printed circuit board 3. The bracket antenna 4 is a sheet metal strip which is provided with one or more longitudinal beads 5 to stiffen it. The longitudinal beads 5 extend from the main section on both sides into a curved section, for example an end section, that adjoins the main section, and effect mechanical stiffening of the sheet metal strip that forms the clamp antenna 4.

The main section can be widened in its center. The longitudinal beads 5 can end before such a widened area of the main section.

As FIG. 1 shows, the bracket antenna 4 can extend along a diagonal of the printed circuit board 3, which is substantially rectangular or square in shape. If the tire pressure monitoring unit is intended to be mounted on a tire valve, as illustrated in the embodiment, the bracket antenna 4 in the housing 1 is preferably arranged such that it encloses an angle of 40° to 50° with the axis of the tire valve when the housing 1 is attached on the shaft of the tire valve. In the embodiment shown, the housing 1 has an opening 6 through which the shaft of the tire valve projects in the mounted state.

The printed circuit board 3 forms the ground plane to the bracket antenna 4. In order to improve the radiation properties of the bracket antenna 4, the ground plane may be omitted at one of the ends of the bracket, in particular, a corner section of the printed circuit board 3 may be without a closed metallic layer. In other words, the printed circuit board 3 is not metallized on the surface around one end of the bracket antenna 4, but has there only conductive tracks for electrically contacting the bracket antenna 4.

The printed circuit board 3 can be assembled on one or both sides, i.e. carries electric and/or electronic components on both sides. The printed circuit 3 may be assembled on both sides to make better use of the available installation space. In the embodiment shown, the printed circuit board 3 additionally carries a second antenna circuit, which is designed for sending pressure data in a frequency range of 433 MHz by means of the bracket antenna 4. The control of the tire pressure monitoring unit selects which one of the two antenna circuits is to transmit pressure data, thus either at 2.4 GHz via Bluetooth LE or in the frequency range of 433 MHz.

What is claimed is:

1. A tire pressure monitoring unit, comprising:
a pressure sensor for measuring a tire pressure; and
a printed circuit board carrying an antenna circuit for transmitting a pressure data;
wherein the antenna circuit is configured to transmit the pressure data by means of Bluetooth low-energy technology and for this purpose has a bracket antenna, the ends of which are secured on the printed circuit board.

2. The tire pressure monitoring unit according to claim 1, wherein the bracket antenna extends along a diagonal of the printed circuit board.

3. The tire pressure monitoring unit according to claim 1, wherein the ends of the bracket antenna are plugged into the printed circuit board.

4. The tire pressure monitoring unit according to claim 1, including a housing that has an opening for attachment to a shaft of a tire valve, wherein the bracket antenna is arranged in the housing such that it encloses an angle of 40° to 50° with the axis of the tire valve when the housing is attached onto the shaft of the tire valve.

5. The tire pressure monitoring unit according to claim 1, wherein the printed circuit board has a metallized ground plane, wherein the printed circuit board is not metallized in at least one corner of the printed circuit board in which one end of the bracket antenna is arranged.

6. The tire pressure monitoring unit according to claim 1, wherein the printed circuit board is assembled on both sides.

7. The tire pressure monitoring unit according to claim 1, wherein the bracket antenna has a main section which extends parallel to the printed circuit board.

8. The tire pressure monitoring unit according to claim 1, wherein the bracket antenna is a sheet metal strip with a longitudinal bead.

9. The tire pressure monitoring unit according to claim 1, wherein the bracket antenna is a sheet metal strip with a longitudinal bead and has a main section which extends parallel to the printed circuit board, wherein a curvature adjoins the main section on both sides and the bead or one of the beads extends beyond the respective curvature into the main section.

10. The tire pressure monitoring unit according to claim 1, wherein the printed circuit board additionally carries a second antenna circuit which is designed for sending pressure data in a frequency range of 433 MHz by means of the bracket antenna, and the tire pressure monitoring unit includes a control circuit which selects by means of which of the two antenna circuits pressure data is to be transmitted.
